(19) United States
(12) Patent Application Publication
(10) Pub. No.: US 2009/0230050 A1
(43) Pub. Date: Sep. 17, 2009

(54) Filter Assembly Sump Liner

(76) Inventors: Steven T. Jersey, Laguna Niguel, CA (US); Michael Saveliev, Huntington Beach, CA (US)

Correspondence Address: GREENBERG TRAURIG (PHX), INTELLECTUAL PROPERTY DEPARTMENT, 2450 COLORADO AVENUE , SUITE 400E, SANTA MONICA, CA, 90404, US

(21) Appl. No.: 12/253,049

(22) Filed: Oct. 16, 2008

Related U.S. Application Data
(60) Provisional application No. 60/999,190, filed on Oct. 17, 2007.

(51) Int. Cl. B01D 35/02; B01D 35/31; B01D 35/16

(52) U.S. Cl. 210/444; 210/541

(57) ABSTRACT

Embodiments of the disclosure provide a sump liner for use with a fluid filter assembly in an appliance. The sump liner includes an open end configured to be coupled to the housing and a closed end opposite from the open end. The sump liner includes a body between the open end and the closed end with the body including at least one corrugated wall. The sump liner includes a cartridge-receiving cavity formed by the body and the closed end. The cartridge-receiving cavity is configured to at least partially cover a filter cartridge when the filter cartridge is inserted into and removed from the sump. The sump liner substantially prevents fluid from the filter cartridge from contacting the sump.

### BACKGROUND

Many generic filtration applications involve using replaceable filters or filter cartridges which are mounted in a filter assembly. The configuration of the filter assembly and/or or the application, such as when the filter assembly is incorporated in an appliance, often make replacing the filter cartridge a difficult and/or disorderly task. The removal of the filter cartridge sometimes results in spilling filtrate or even filter media.

### SUMMARY

Some embodiments of the disclosure provide a sump liner for use with a fluid filter assembly in an appliance. The sump liner includes an open end configured to be coupled to the housing and a closed end opposite from the open end. The sump liner includes a body between the open end and the closed end with the body including at least one corrugated wall. The sump liner includes a cartridge-receiving cavity formed by the body and the closed end. The cartridge-receiving cavity is configured to at least partially cover a filter cartridge when the filter cartridge is inserted into and removed from the sump. The sump liner substantially prevents fluid from the filter cartridge from contacting the sump.

### DESCRIPTION OF THE DRAWINGS

FIG. 1 is an exploded view of a fluid filter assembly including a sump liner according to one embodiment of the disclosure.

FIG. 2 is an exploded view of a filter cartridge for use with the fluid filter assembly of FIG. 1.

FIG. 3 is a cross-sectional view of the filter cartridge of FIG. 2 taken along line 3-3 of FIG. 2.

FIG. 4 is a top view of the sump liner included in the fluid filter assembly of FIG. 1.

### DETAILED DESCRIPTION

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings. Unless otherwise apparent, or stated, directional references, such as “inner,” “outer,” “upper,” “lower,” etc., or variations thereof, are intended to be relative to the parts described or orientation of a particular embodiment of the disclosure as shown in the first view of that embodiment.

The following discussion is presented to enable a person skilled in the art to make and use embodiments of the disclosure. Various modifications to the illustrated embodiments will be readily apparent to those skilled in the art, and the generic principles herein can be applied to other embodiments and applications without departing from embodiments of the disclosure. Thus, embodiments of the disclosure are not intended to be limited to embodiments shown. but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the disclosure. Skilled artisans will recognize the examples provided herein have many useful alternatives and fall within the scope of embodiments of the disclosure.

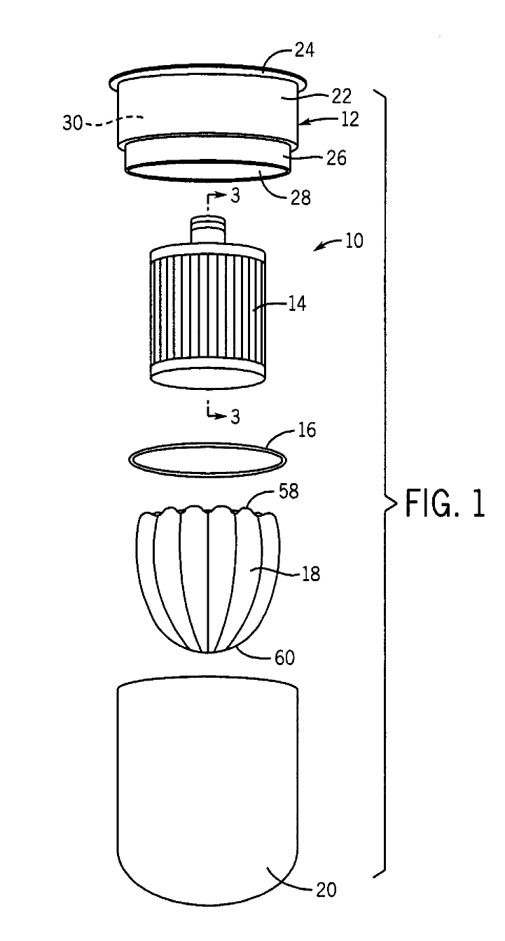

FIG. 1 illustrates a filter assembly 10 according to one embodiment of the disclosure, as can be generally used in refrigerators or similar kitchen appliances. In some embodiments, filter assembly 10 generally includes a filter housing 12, a filter cartridge 14, an O-ring gasket 16, a sump liner 18, and a filter cup or sump 20. The filter assembly 10 shown in FIG. 1 is only for purposes of illustrating various features of embodiments of the disclosure, in that other filter assemblies, such as filter assemblies having alternate configurations or components, can include features comprising an embodiment encompassed by the disclosure. Moreover, a filter assembly according to the disclosure, such as filter assembly 10, can be utilized in applications other than those involving refrigerators or kitchen appliances generally.

Filter housing 12 includes a substantially cylindrical body 22 defined between an attachment portion 24 and a receiving portion 26. Although not specifically shown in FIG. 1, attachment portion 24 is adapted or configured to facilitate a substantially secure, non-permanent attachment for filter housing 12 in its intended location. For example, attachment portion 24 may include a threaded section, flange or other suitable features for coupling filter housing 12 to a refrigerator or other appliance. In other embodiments, filter housing 12 can include other mechanisms either associated with attachment portion 24 or otherwise that facilitate the positioning of filter housing 12 in its intended location. Filter housing 12 can also be integral to a refrigerator or any other device with which filter assembly 10 is to be installed. Filter housing 12 is also configured to mate with cup 20, which can be accomplished through a suitable attachment mechanism, such as corresponding threading on the outer surface of receiving portion 26 and the inner surface of sump 20.

Receiving portion 26 of filter housing 12 includes an opening 28 which at least partially defines an interior space 30 configured to receive other components of filter assembly 10. For example, components received by filter housing 12 include filter cartridge 14, ring gasket 16, sump liner 18, and sump 20. Other components can also be included within filter assembly 10 and received by filter housing 12. In some embodiments, filter housing 12 can be configured for connecting with the fluid inlet and outlet lines from an appliance, while opening 28 and interior space 30 provide for fluid communication between components of filter assembly 10 and the respective inlet and outlet fluid lines.

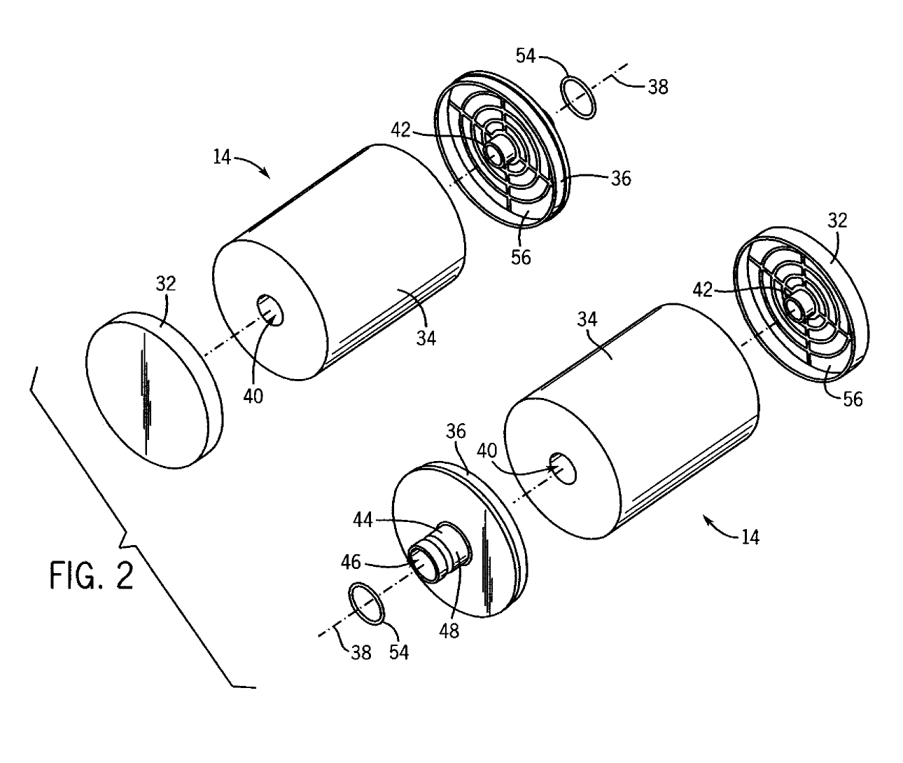

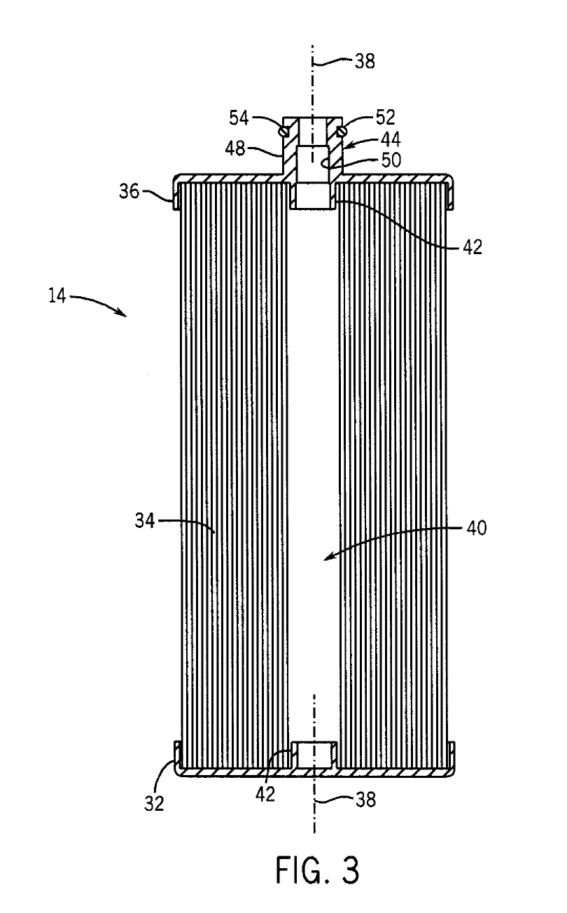

As shown in FIGS. 2 and 3, filter cartridge 14 of filter assembly 10 can include a first filter cap 32, a filter media 34, and a second filter cap 36. Filter media 34 can be substantially cylindrical having a central longitudinal axis 38 with a substantially cylindrical conduit 40 that is aligned with axis 38. The disclosure is not limited to any particular filter media 34 shape, and filter media 34 can comprise other shapes than shown in this embodiment. Additionally, other embodiments can include filter medium and conduits which are not axially aligned.

First filter cap 32 and second filter cap 36 can each generally include a conduit extension 42 in axial alignment with axis 38 and dimensioned to be inserted within cylindrical conduit 40. Second filter cap 36 further includes a neck portion 44 extending from filter cartridge 14 along axis 38 in substantially the opposite direction as extension 42 of second filter cap 36. Neck portion 44 and extension 42 of second filter cap 36 cooperate to form a passage 46 which provides for fluid communication with conduit 40 in filter media 34 and extension 42 of first filter cap 32.

Neck portion 44 of second filter cap 36 includes an outside surface 48 and a stepped inside surface 50, forming portions of passage 46 that differ in diameter. Outside surface 48 includes an annular recessed groove 52 configured to seat an O-ring gasket 54 therein. As shown in FIG. 2, first filter cap 32 and second filter cap 36 can include a plurality of apertures 56 formed in a generally concentric arrangement with respect to axis 38 in filter caps 32 and 36.

In some embodiments, Filter assembly 10 is assembled by filter cartridge 14 being inserted in receiving portion 26. Fluid provided to interior space 30 through a connection between a fluid inlet line (not shown) and filter housing 12 is introduced to filter media 34 through apertures 56. Similarly, in some embodiments, neck portion 44 can be connected for fluid communication within interior space 30 with a fluid outlet line (not shown). In such embodiments, filtered fluid can pass through filter media 34 and out of fluid assembly 10 through conduit 40 and passage 46 in neck portion 44. However, other embodiments can include an alternative fluid path.

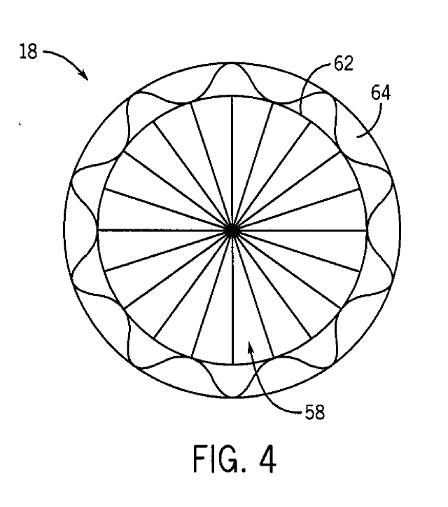

As shown in FIGS. 1 and 4, sump liner 18 in some embodiments generally includes an open end 58 and a closed end 60. In some embodiments, closed end 60 of sump liner 18 generally corresponds with the overall shape of filter cup 20, though sump liner 18 is not limited to conforming with any particular shape. In other embodiments, sump liner 18 can be shaped other than as shown herein. In some embodiments, sump liner 18 is formed from or into a corrugated material. As shown in FIG. 4, sump liner 18, as can be seen particularly at open end 58, generally defines a star-like patterned shape, defining inner portions 62 and outer portions. The corrugated configuration of sump liner 18 can define alternating inner and outer channels (e.g., inner and outer portions 62 and 64, respectively) and/or alternating grooves and ridges in the walls of sump liner 18. The alternating inner and outer channels or grooves and ridges can be substantially parallel to one another. The sump liner 18 can be formed of, or into, a non-corrugated structure, a pleated structure, or a film.

Inner portions 62 of sump liner 18 generally correspond to the folded sections of the corrugated material that are adjacent filter cartridge 14 when sump liner 18 is mounted in the assembled filter assembly 10. Outer portions 64 of sump liner 18 generally correspond to the folded sections of the corrugated material that are adjacent the inner wall (not shown) of sump 20 upon sump liner 18 being mounted in the assembled filter assembly 10.

In some embodiments, sump liner 18 is mounted in filter assembly 10 by coupling sump liner 18 with the filter cartridge 14. Sump liner 18 can form a protective sheath around part or all of filter cartridge 14. Sump liner 18 can be positioned to abut second filter cap 36. In some embodiments, ring gasket 16 can be mounted on sump liner 18 or otherwise cooperate to secure open end 58 of sump liner 18 over Filter cartridge 14. In some embodiments, sump liner 18 can be of a substantially larger longitudinal length than filter cartridge 14, so as to leave extra or slack corrugated material which can then be folded over or otherwise manipulated to substantially surround ring gasket 16. Thus, sump liner 18, and/or the portion of slack material associated with open end 58, can serve additional functions within filter assembly 10, such as affecting the rate of fluid flow therein, providing further filtration aspects or enhancing sealing characteristics and the integrity of fluid flow through filter assembly 10, and filter cartridge 14 and sump 20 in particular.

In other embodiments, sump liner 18 can be mounted to an inner portion (not shown) of filter housing 12, which is further configured and operable to support filter cartridge 14 and provide for the coupling of fluid inlet and outlet lines with filter cartridge 14. Ring gasket 16 can be mounted in close proximity to open end 58 of sump liner 18 for sealing fluid from passing from the fluid inlet and outlet lines to the sump 20, among other things.

In yet other embodiments, sump liner 18 is dimensioned and configured so that inner portions 62 of sump liner 18 generally provide a tight fit or otherwise closely contact filter cartridge 14 when sump liner 18 is mounted within filter assembly 10. Similarly, sump liner 18 can be dimensioned and configured so that outer portions 64 generally provide a tight fit or closely conform with the inner wall (not shown) of sump 20 when the sump liner 18 is mounted within filter assembly 10.

Sump liner 18 can be formed of a pliant or compressible material, or can otherwise be slightly or partially deformable, particularly when mounted in filter assembly 10. Sump liner 18 can be constructed of a suitable material or combination of materials, which can be corrugated or non-corrugated, porous or non-porous, such as a paper, paperboard or plastics, such as polyethylene or polypropylene, and combinations thereof. In some embodiments, sump liner 18 can be fabricated to be partially or substantially fluid impermeable. In some embodiments, sump liner 18 can be constructed of a disposable material.

Sump liner 18 can be used to help prevent fluid and/or filter media from being spilled out of the filter cartridge 14 when the filter cartridge 14 is being removed from the filter assembly 10. Sump liner 18 and filter cartridge 14 can be removed from filter assembly 10 together, so that sump liner 18 can contain any fluid and/or filter media that spills from the filter cartridge 14. Thus, sump liner 18 and filter cartridge 14 can be disposed of upon opening filter assembly 10 to replace filter cartridge 14, which can then be provided with a new filter cartridge 14 and sump liner 18.

It will be appreciated by those skilled in the art that while the disclosure has been described above in connection with particular embodiments and examples, the disclosure is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

Various features and advantages of the disclosure are set forth in the following claims.

1. A fluid filter assembly for use with an appliance and a filter cartridge, the appliance providing an inlet line and an outlet line, the fluid filter assembly comprising:
a housing configured to be coupled to the inlet line to receive an unfiltered fluid stream from the appliance and configured to be coupled to the outlet line to provide a filtered fluid stream to the appliance;
a sump configured to be releasably coupled to the housing, the sump including a liner-receiving cavity; and
a sump liner configured to be removeably positioned in the liner-receiving cavity, the sump liner including a cartridge-receiving cavity, the sump liner including at least one corrugated wall, the cartridge-receiving cavity at least partially covering the filter cartridge when the filter cartridge is installed in the sump and when the filter cartridge is being removed from the sump.

2. The fluid filter assembly of claim 1, wherein the sump liner is coupled directly to the filter cartridge.

3. The fluid filter assembly of claim 1, wherein an open end of the sump liner is coupled to the filter cartridge by an annular gasket.

4. The fluid filter assembly of claim 1, wherein the at least one corrugated wall defines alternating inner and outer channels.

5. The fluid filter assembly of claim 1, wherein an open end of the sump liner defines a star-like shape.

6. The fluid filter assembly of claim 1, wherein the sump liner is fabricated of a substantially impermeable material.

7. The fluid filter assembly of claim 1, wherein the sump liner is fabricated of a deformable material.

8. The fluid filter assembly of claim 1, wherein the sump liner is fabricated of a material that substantially prevents fluid contact with the liner-receiving cavity of the sump.

9. The fluid filter assembly of claim 1, wherein the Sump liner is configured so that the filter cartridge fits completely within the cartridge-receiving cavity and a portion of the sump liner extends over an upper portion of the filter cartridge.

10. A sump liner for use with a fluid filter assembly of an appliance, the fluid filter assembly including a filter cartridge, a housing, and a sump, the sump liner comprising:
an open end configured to be coupled to the housing;
a closed end opposite from the open end;
a body between the open end and the closed end, the body including at least one corrugated wall; and
a cartridge-receiving cavity formed by the body and the closed end, the cartridge-receiving cavity configured to substantially cover the filter cartridge when the filter cartridge is inserted into and removed from the sump, the sump liner substantially preventing fluid from the filter cartridge from contacting the sump.

11. The sump liner of claim 10, wherein the at least one corrugated wall of the sump liner defines alternating inner channels and outer channels.

12. The sump liner of claim 10, wherein the at least one corrugated wall of the sump liner defines alternating ridges and grooves.

13. The sump liner of claim 10, wherein the sump liner is coupled directly to the filter cartridge.

14. The sump liner of claim 10, wherein an open end of the sump liner is coupled to the filter cartridge by an annular gasket.

15. The sump liner of claim 10, wherein the sump liner is fabricated of a substantially liquid impermeable material.

16. The sump liner of claim 10, wherein the sump liner is fabricated of a substantially compressible material.

17. The sump liner of claim 10, wherein the at least one corrugated wall of the sump liner is partially deformed when inserted into the sump.
